(19) United States
(12) Patent Application Publication
(10) Pub. No.: US 2012/0050645 A1
(43) Pub. Date: Mar. 1, 2012

(54) IMAGE DISPLAY APPARATUS

(75) Inventors: Tomohiko OKADA, Osaka (JP); Tetsushi ITO, Osaka (JP); Kenji TANAKA, Osaka (JP); Hirotoshi IEMURA, Osaka (JP); Masakatsu KUSUDA, Osaka (JP); Hiroshi KAMIYAMA, Osaka (JP); Masaki NISHIZAKA, Osaka (JP)

(73) Assignee: SHARP KABUSHIKI KAISHA, Osaka (JP)

(21) Appl. No.: 13/217,454

(22) Filed: Aug. 25, 2011

(30) Foreign Application Priority Data
Aug. 30, 2010 (JP) 2010-192920

(51) Int. Cl. G02F 1/13357

(52) U.S. Cl. 349/64

(57) ABSTRACT

An image display apparatus includes a liquid crystal panel that displays an image on one face side; a chassis arranged on another face side of the liquid crystal panel; a frame section that faces an outer edge section of the liquid crystal panel from the one face side; a light source that irradiates the liquid crystal panel with light from the other face side; a diffuser plate disposed between the light source and the liquid crystal panel; and a frame-shaped holding structure that is disposed on a sidewall section of the chassis and holds the liquid crystal panel and the diffuser plate. The holding structure is provided with a panel holding section that holds the outer edge section of the liquid crystal panel with the frame section therebetween, and a diffuser plate holding section that supports an outer edge section of the diffuser plate with a curved reflection surface.

### CROSS-REFERENCE TO RELATED APPLICATION

This application claims priority to Japanese Patent Application No. 2010-192920, which was filed on Aug. 30, 2010, the contents of which are incorporated herein by reference in its entirety.

### BACKGROUND OF THE TECHNOLOGY

1. Field of the Technology

The present technology relates to an image display apparatus for displaying an image.

2. Description of the Related Art

An image display apparatus such as a liquid crystal display apparatus includes a liquid crystal panel, a backlight chassis having a light source that emits light from a back side of the liquid crystal panel arranged on the bottom of the backlight chassis and serves as a base to be used for fixation of the liquid crystal panel, and a frame-shaped bezel. An outer edge section in a planar direction of the liquid crystal panel is held between the bezel and the backlight chassis. Such an image display apparatus, in order to improve image quality of an image displayed, has a diffuser plate, an optical sheet and the like that are layered between the liquid crystal panel and the light source, and controls light that is emitted from the light source to the liquid crystal panel.

The diffuser plate diffuses light emitted from the light source in the planar direction so that luminance is prevented from being locally distributed. The diffuser plate is made of a resin, and is thus easily subjected to expansion and deformation by heat that is generated from the light source. Therefore, the diffuser plate is not fixed to the backlight chassis with use of a fixing member but held by coming in contact with a frame-shaped holding section parallel to a bottom section of the backlight chassis from outside in the planar direction (refer to Japanese Unexamined Patent Publication JP-A 2009-109691).

In an image display apparatus in which widths of a backlight chassis and a bezel viewed from a display screen side are made as small as possible (with a thin bezel), it is difficult to install a holding section for holding a diffuser plate in surface contact with an outer edge section of the diffuser plate in the outside in a planar direction of the display screen (install outside an effective display area). Therefore, in the image display apparatus with a thin bezel, the holding section is installed inside in the planar direction of the display screen (installed in the effective display area).

In this manner, the diffuser plate that is held by the holding section installed in the effective display area has an outer edge section that is held in surface contact with a planar part of the holding section, and a surface contact part with the holding section is thus not irradiated directly with light, so that an outgoing efficiency with respect to light emitted from a light source is lowered and luminance uniformity on a display screen is likely to be deteriorated.

Additionally, in a case where a width dimension of the holding section is made smaller according to thin bezel configuration of the backlight chassis and the bezel, when the diffuser plate is exposed to a low temperature to be contracted before starting up of an apparatus and the like, an outer edge section of the diffuser plate is likely to come off from the holding section. In a case where the outer edge section of the diffuser plate comes off from the holding section in this manner, even when the diffuser plate is expanded by heat that is generated from the light source in completion of stating up of an apparatus, it is difficult for the outer edge section of the diffuser plate to return smoothly to a position at which the holding section holds, and luminance uniformity on a display screen is likely to be deteriorated.

### SUMMARY OF THE TECHNOLOGY

Hence, an object of the technology is to provide an image display apparatus capable of suppressing deterioration of luminance uniformity on a display screen.

The technology provides an image display apparatus comprising:

a liquid crystal panel having a liquid crystal element that displays an image on a display screen arranged on one side thereof, with the liquid crystal element;

a base that is arranged on another side opposite to the one side of the liquid crystal panel, and has a bottom plate and a sidewall disposed on a lateral part of the bottom plate;

a member that faces an outer edge section of the liquid crystal panel from the one side thereof, and prevents relative displacement to the one side of the liquid crystal panel;

a light source that is disposed on the bottom plate of the base, and irradiates the liquid crystal panel with light from the other side of the liquid crystal panel;

a diffuser plate that is disposed between the light source and the liquid crystal panel, and diffuses light emitted from the light source; and
a holding structure having a frame shape that is disposed on the sidewall of the base, reflects light emitted from the light source and holds the diffuser plate, the holding structure being provided with a diffuser plate holding section that supports an outer edge section of the diffuser plate on a supporting surface formed in a curved surface.

The image display apparatus comprises a liquid crystal panel that displays an image on a display screen arranged on one side thereof, with a liquid crystal element; a base that is arranged on another side of the liquid crystal panel; a member that faces an outer edge section of the liquid crystal panel from the one side thereof; a light source that irradiates the liquid crystal panel with light from the other side of the liquid crystal panel; a diffuser plate that is disposed between the light source and the liquid crystal panel and diffuses light emitted from the light source; and a holding structure having a frame shape that is disposed on a sidewall of the base, reflects light emitted from the light source and holds the diffuser plate. Further, the holding structure is provided with a diffuser plate holding section that supports an outer edge section of the diffuser plate on a supporting surface formed in a curved surface.

The diffuser plate, whose outer edge section is supported by the supporting surface formed in the curved surface of the diffuser plate holding section that reflects light emitted from the light source, enables light emitted from the light source to be entered between the diffuser plate and the supporting surface in the outer edge section of the diffuser plate. This makes it possible to suppress lowering of an outgoing efficiency with respect to the light emitted from the light source so as to suppress deterioration of luminance uniformity on a display screen. Additionally, it is possible for the light emitted from the light source to be entered between the diffuser plate and the supporting surface in the outer edge section of the diffuser plate, thus having smooth decay of a light quantity in the outer edge section of the diffuser plate, and it is thus possible to obscure ununiformity of a display image.

Further, even in a case where the diffuser plate is exposed to a low temperature to be contracted before starting up of the apparatus and the like, when the diffuser plate is expanded by heat that is generated from the light source in completion of stating up of the apparatus, the outer edge section of the diffuser plate is guided to the curved supporting surface to be able to return smoothly to an original position before contraction. This makes it possible to suppress lowering of an outgoing efficiency with respect to light emitted from the light source in the diffuser plate, and it is thus possible to suppress deterioration of luminance uniformity on a display screen.

Further, it is preferable that the diffuser plate holding section has an inclined surface that is inclined toward the bottom plate that is laid in a direction coming close to the light source from the supporting surface.

The diffuser plate holding section having a function that reflects light emitted from the light source has an inclined surface that is inclined toward the bottom plate that is laid in a direction coming close to the light source from the supporting surface. This enables the light emitted from the light source to be reflected toward the diffuser plate with the inclined surface, and it is thus possible to further suppress deterioration of luminance uniformity on a display screen.

Further, it is preferable that the supporting surface of the diffuser plate holding section has an arc shape.

A supporting surface of the diffuser plate holding section has an arc shape. This enables light emitted from the light source to be entered between the diffuser plate and the supporting surface in the outer edge section of the diffuser plate.

Further, it is preferable that the holding structure is disposed so that at least a part of the supporting surface of the diffuser plate holding section is located inside in a planar direction on the display screen in the liquid crystal panel.

A holding structure is disposed so that at least a part of a supporting surface of the diffuser plate holding section is located inside in a planar direction on a display screen in the liquid crystal panel. In the image display apparatus, since it is possible for light emitted from the light source to be entered between the diffuser plate and the supporting surface in the outer edge section of the diffuser plate by forming the supporting surface of the diffuser plate holding section in a curved surface, even in a case where at least a part of the supporting surface is located inside in a planar direction on a display screen in the liquid crystal panel, that is, at least a part of the supporting surface is located in an effective display area according to thin bezel configuration in which a width of a member facing the base and an outer edge section of the liquid crystal panel from one side is made smaller, it is possible to suppress deterioration of luminance uniformity on a display screen.

Further, it is preferable that the image display apparatus comprises:
an optical sheet that is disposed between the diffuser plate and the liquid crystal panel, and changes an optical property of light that is transmitted through the diffuser plate, and

a projecting section that is vertically disposed toward the diffuser plate from the bottom plate of the base, and regulates flexural deformation of the diffuser plate.

The image display apparatus further comprises an optical sheet that is disposed between the diffuser plate and the liquid crystal panel, and changes an optical property of light that is transmitted through the diffuser plate, and a projecting section that is vertically disposed toward the diffuser plate from the bottom plate of the base, and regulates flexural deformation of the diffuser plate. Whereby, in the diffuser plate, the outer edge section is supported by the diffuser plate holding section, displacement thereof to a liquid crystal panel side is regulated by the optical sheet, and the displacement thereof to the bottom plate of the base is regulated by the projecting section. Therefore, since the diffuser plate comes to be subjected to three-dimensional position regulation by the diffuser plate holding section, the optical sheet and the projecting section, even in a case where a size of the diffuser plate is made smaller according to thin bezel configuration in which a width of a member facing the base and the outer edge section of the liquid crystal panel from one side is made smaller, it is possible to prevent the diffuser plate from being deviated to be fallen out.

### BRIEF DESCRIPTION OF THE DRAWINGS

Other and further objects, features, and advantages of the technology will be more explicit from the following detailed description taken with reference to the drawings wherein:

FIG. 1 is a plan view of an image display apparatus according to one embodiment;

FIG. 2 is a cross-sectional view of the image display apparatus shown in FIG. 1 taken along the line A-A;

FIG. 3 is an enlarged view showing a main part of the image display apparatus;

FIG. 4 is a view showing a configuration of an image display apparatus according to another embodiment; and

FIG. 5 is an enlarged view showing a main part of the image display apparatus.

### DETAILED DESCRIPTION

Now referring to the drawings, preferred embodiments are described below.

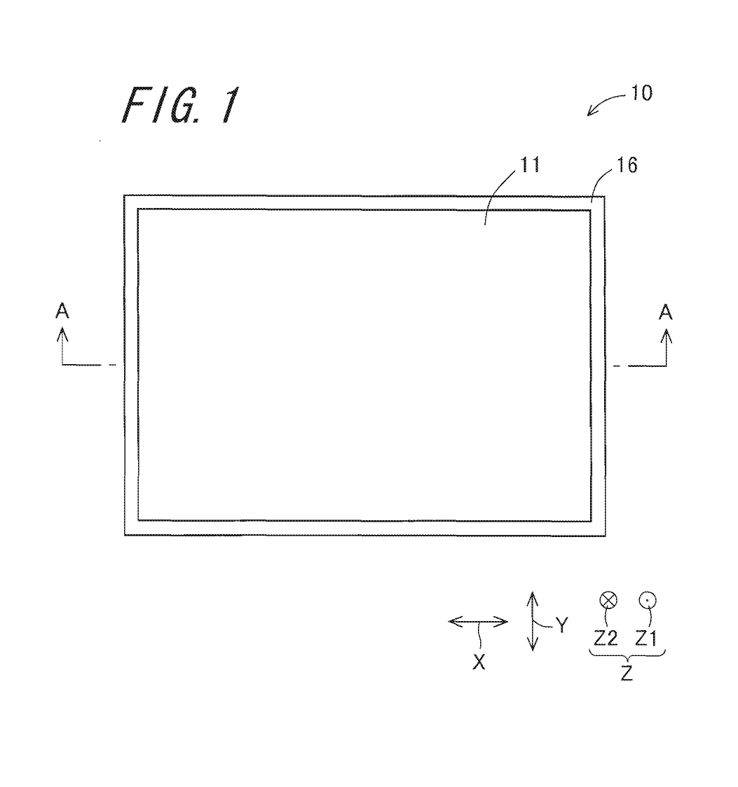

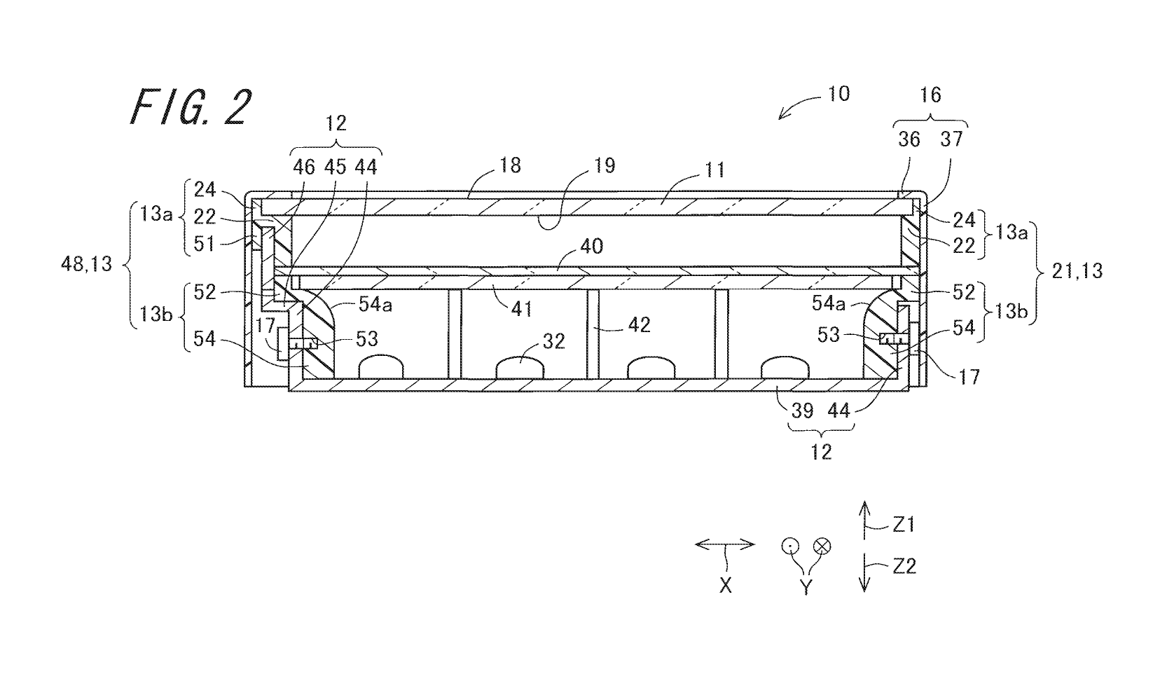

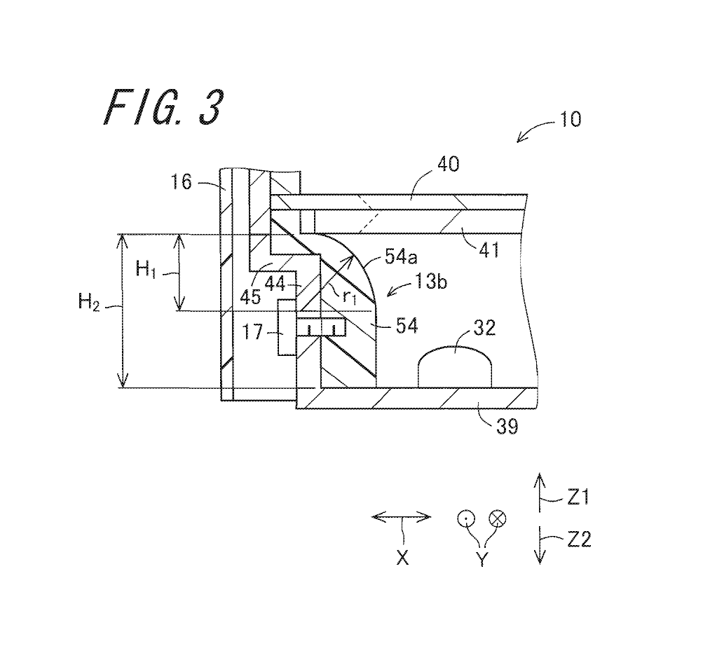

FIG. 1 is a plan view of an image display apparatus 10 according to one embodiment. FIG. 2 is a cross-sectional view of the image display apparatus 10 shown in FIG. 1 taken along the line A-A. FIG. 3 is an enlarged view showing a main part of the image display apparatus 10.

The image display apparatus 10 comprises a liquid crystal panel 11, a chassis 12 that serves as a base, a holding structure 13, a frame section 16, a connecting member 17, a light source 32, an optical sheet 40 and a diffuser plate 41.

In the embodiment, the image display apparatus 10 is a television set or a display apparatus that displays an image on a display screen based on image information that is outputted from a personal computer or the like. The display screen is formed by the liquid crystal panel 11 having a liquid crystal element, and the liquid crystal panel 11 is formed in a flat plate shape. In the liquid crystal panel 11, two directions in a thickness direction Z are denoted by a front side Z1 and a back side Z2.

The liquid crystal panel 11 has a liquid crystal element, and displays an image on one face 18 side by the liquid crystal element. The chassis 12 is a base that is used for fixation of the liquid crystal panel 11, having a plurality of the light sources 32 mounted thereon, and arranged on another face 19 side opposite to the one face 18 side of the liquid crystal panel 11. The one face 18 side is the front side Z1, and the other face 19 side is the back side Z2.

The image display apparatus 10 displays an image so as to be visible when viewed from the front side Z1. In the image display apparatus 10, concerning a flat-plate-shaped part that is arranged parallel to the liquid crystal panel 11, terms of “front side” (Z1) and “back side” (Z2) are used as meaning the same directions as those on the basis of the liquid crystal panel 11.

The liquid crystal panel 11 includes two substrates (not shown), and is formed in a rectangular plate shape when viewed in the thickness direction Z. The liquid crystal panel 11 includes a switching element such as a TFT (thin film transistor), and has a liquid crystal injected in a gap between the two substrates. The liquid crystal panel 11 is irradiated with light from the light source 32 on the back side Z2 as backlight, thereby exerting a display function. On the two substrates, a driver (source driver) for drive control of pixels in the liquid crystal panel 11, various elements and wires are disposed.

The frame section 16 is a member that faces an outer edge section of the liquid crystal panel 11 from the one face 18 side, and surrounds a periphery of the liquid crystal panel 11 from outside in a planar direction thereof. The frame section 16 includes a flat-plate-shaped section 36 that is vertical to the thickness direction Z, and an outer periphery section 37 that surrounds the liquid crystal panel 11 from outside in the planar direction thereof. The flat-plate-shaped section 36 holds the outer edge section of the liquid crystal panel 11 together with the holding structure 13 therebetween. Whereby, relative displacement of the liquid crystal panel 11 to the one face 18 side with respect to the frame section 16 is prevented.

In the image display apparatus 10, the frame section 16 that surrounds the periphery of the liquid crystal panel 11 from outside in the planar direction thereof has so-called thin bezel configuration. For example, in a case where the image display apparatus 10 is used for a multi-display system, a plurality of the image display apparatuses 10 are arranged along one direction or in a matrix. At the time, a part that corresponds to a boundary of the image display apparatuses 10 that are adjacent to each other, that is, the frame section 16 is a non-display part where an image is not displayed. In the multi-display, images that are displayed on the image display apparatuses 10 that are adjacent to each other are essentially successive images, however, when a width of the frame section 16 viewed from the Z direction is large, a width of the non-display part becomes large. In the image display apparatus 10 as used for the multi-display system, in order to reduce the width of the non-display part as much as possible, thin bezel configuration in which the width of the frame section 16 is reduced is desired. In the embodiment, the image display apparatus 10 is a thin-bezel liquid crystal display apparatus having the liquid crystal panel 11 with a 60-inch diagonal line and an aspect ratio of 9 to 16.

Moreover, the image display apparatus 10 has the frame section 16 and the liquid crystal panel 11 that are formed in a rectangle shape when viewed from the front side Z1. Such rectangles may be arranged longitudinally or arranged laterally in a typical posture when the image display apparatus 10 displays an image, however, are arranged laterally in the embodiment.

The chassis 12 is a base that is used for fixation of the liquid crystal panel 11, and includes a bottom section 39 that is a flat-plate-shaped bottom plate which is vertical to the thickness direction Z and parallel to the liquid crystal panel 11; sidewall sections 44 which are a sidewall that continues into the bottom section 39 and erected from the bottom section 39; and a flat-plate-shaped flange section 45 that continues into a part on a side opposite to the part into which the bottom section 39 continues in the sidewall sections 44, and expands parallel to the bottom section 39. The bottom section 39 is formed in a rectangle shape when viewed in the thickness direction Z. The sidewall sections 44 are formed so as to be erected on the front side Z1 from two ends forming short sides and two ends forming long sides of the bottom section 39. Thereby, flat-plate-shaped four sidewall sections 44 are formed in the periphery of the bottom section 39.

Each of the sidewall sections 44 is formed in a rectangle shape, and parallel to the thickness direction Z of the bottom section 39. At ends on the most front side Z1 in the sidewall sections 44, the flange section 45 is continued. The flange section 45 is formed so as to be expanded to the outside in the planar direction of the bottom section 39 when viewed in the thickness direction Z, and two of which are formed in the embodiment. The flange section 45 is formed in a long and thin rectangle shape vertical to the thickness direction Z of the bottom section 39. The flange section 45 is formed in a rectangle shape when viewed in the thickness direction Z. The term “vertical” includes both meanings of “ideally vertical” and “substantially vertical”, and the term “parallel” includes both meanings of “ideally parallel” and “substantially parallel”.

In the embodiment, in the flange section 45, a collar section 46 is formed on a side opposite to the end continuing into the sidewall section 44 so as to be further projected to the front side Z1 from an end that is located outside in the planar direction with respect to the bottom section 39. The collar section 46 is formed in a rectangle shape parallel to the thickness direction Z. Additionally, the collar section 46 is formed corresponding to two flange sections 45. In the embodiment, the collar section 46 is formed corresponding to one flange section 45 forming a short side and one flange section 45 forming a long side, respectively.

Furthermore, a reflective sheet may be provided in contact with at least a part of the surface on the front side Z1 of the bottom section 39. A surface facing at least the front side Z1 of the reflective sheet has high reflectance, and ideally reflectance of 100%, with respect to light emitted from the light source 32.

The light source 32 is provided on the bottom section 39 of the chassis 12, and irradiates the liquid crystal panel 11 with light from the other face 19 side. In the embodiment, as the light source 32, a plurality of LEDs (Light Emitting Diode) serving as a light-emitting element are arranged in a matrix on the bottom section 39. Additionally, in the light source 32 comprising a plurality of LEDs, an optical element (lens) is provided so as to cover each of the plurality of LEDs. Such an optical element condenses or diffuses light emitted from the LED. The light emitted from the light source 32 is transmitted through the diffuser plate 41 and the optical sheet 40, further through the liquid crystal panel 11, to be emitted to the front side Z1 of the image display apparatus 10, and is used as display light for performing image display.

The diffuser plate 41 is disposed between the light source 32 and the liquid crystal panel 11 on the front side Z1 with respect to the light source 32, and diffuses light emitted from the light source 32 in a planar direction, thereby preventing local distribution of luminance. The diffuser plate 41 is arranged parallel to the liquid crystal panel 11.

The holding structure 13 is a frame-shaped member that is provided in the sidewall section 44 of the chassis 12, reflects light emitted from the light source 32 and holds the diffuser plate 41. In the embodiment, the holding structure 13 also holds the liquid crystal panel 11 as well as holds the diffuser plate 41. A surface facing at least the front side Z1 of the holding structure 13 has high reflectance, and ideally reflectance of 100%, with respect to the light emitted from the light source 32. The holding structure 13 includes a displacement prevention member 21 and a fit fixation member 48 that is fitted and fixed to the chassis 12, and the displacement prevention member 21 and the fit fixation member 48 are connected to each other to form a frame shape. Additionally, the displacement prevention member 21 and the fit fixation member 48 comprise a panel holding section 13a and a diffuser plate holding section 13b, respectively. The panel holding section 13a holds the outer edge section of the liquid crystal panel 11 together with the frame section 16 therebetween to hold the liquid crystal panel 11. The diffuser plate holding section 13b has a reflection surface 54a serving as a supporting surface that is formed in a curved surface, and supports an outer edge section of the diffuser plate 41 with the reflection surface 54a to hold the diffuser plate 41.

The fit fixation member 48 is fitted and fixed to at least the collar section 46 of the chassis 12. In the embodiment, the panel holding section 13a of the fit fixation member 48 includes a fitting section 51 in which a concave groove into which the collar section 46 is inserted is formed, and on the front side Z1 of the fitting section 51, a facing section 22 that faces the front side Z1 and faces an outer edge section of the liquid crystal panel 11; and a contact section 24 that is projected to the front side Z1 outside in a planar direction of the facing section 22 to come in contact with the liquid crystal panel 11 from outside in the planar direction are formed. The facing section 22 is a part that holds the outer edge section of the liquid crystal panel 11 together with the flat plate shape section 36 of the frame section 16 therebetween. Therefore, the facing section 22 needs to surely face the outer edge section of the liquid crystal panel 11, and additionally, in the facing section 22, the thinner setting thereof is made as much as possible, the easier realization of thin bezel configuration is able to be made.

Concerning the facing section 22 that comes in contact with ends forming respective sides of the liquid crystal panel 11, a dimension of the facing section 22 in the thickness direction Z and a direction vertical to both of the respective sides is referred to as a “width dimension”. As an example of the image display apparatus 10, for example, in the case of a 60-inch image display apparatus 10, in an effective display area of an image in the liquid crystal panel 11, a dimension in a long side direction X is about 133 cm, and a dimension in a short side direction Y is about 75 cm. In this case, the width dimension of the facing section 22 is set to about 3 mm.

The diffuser plate holding section 13b of the fit fixation member 48 includes a flat section 52 that continues into the fitting section 51 and covers the front side Z1 of the flange section 45, and an inner section 54 that covers the sidewall section 44 of the chassis 12 from an inner periphery side. An end on the front side Z1 of the inner section 54 is formed by continuing into an end located inside in a planar direction of the flat section 52. Then, at the end on the front side Z1 of the inner section 54, a surface on an opposite side to a surface in contact with the sidewall section 44 of the chassis 12 is formed in a curved surface to become the reflection surface 54a that supports an outer edge section of the diffuser plate 41.

Further, at the inner section 54 of the fit fixation member 48, on the side of the surface in contact with the sidewall section 44 of the chassis 12, one or a plurality of holes 53 are formed, and an internal thread is formed in the hole 53. Into the hole 53, the connecting member 17 that is realized by a thread member is inserted. The connecting member 17 is threadably mounted on the hole 53 of the inner section 54 so that the fit fixation member 48 is connected to the chassis 12. Note that, the hole 53 is formed without penetrating the inner section 54. Whereby, light is prevented from being transmitted through the inner section 54.

In the fit fixation member 48, the reflection surface 54a formed in a curved surface at the end on the front side Z1 of the inner section 54 has a convex parabolic or arc shape on the front side Z1, and has an arc shape in the embodiment. Moreover, at least a part of the reflection surface 54a is disposed so as to be located inside in the planar direction on a display screen in the liquid crystal panel 11, that is, located in an effective display area.

In the embodiment, the arc-shaped reflection surface 54a has a cross-sectional shape vertical to the short side direction Y that is a ¼ circle whose center angle is 90°, and is uniformly formed in the short side direction Y. Further, the arc-shaped reflection surface 54a has a length H₁ in the thickness direction Z that is the same as a curvature radius r₁. A ratio (H₁/H₂) of the length H₁ in the thickness direction Z of the reflection surface 54a to the length H₂ in the thickness direction Z of the diffuser plate holding section 13b, that is, the length H₂ from a surface on the back side Z2 of the diffuser plate 41 to the bottom section 39 of the chassis 12 can be appropriately set according to the size of thin bezel configuration of the image display apparatus 10, a heat deformation ratio and a diffusion rate of the diffuser plate 41, and the like, and is set to 0.05 or more. In a case where the (H₁/H₂) is less than 0.05, the length in the long side direction X of the reflection surface 54a is too short to support an outer edge section of the diffuser plate 41, and the diffuser plate 41, in the case of being exposed to a low temperature to be contracted, may be deviated to be fallen out or have light that does not reach the end.

The displacement prevention member 21 is disposed corresponding to parts where the collar section 46 of the chassis 12 is not disposed. In the embodiment, the panel holding section 13a of the displacement prevention member 21 comprises the facing section 22 that faces the outer edge section of the liquid crystal panel 11, and the contact section 24 that is projected to the front side Z1 in the outside in a planar direction of the facing section 22 to come into contact with the liquid crystal panel 11 from outside in the planar direction thereof. The facing section 22 is a part that holds an outer edge section of the liquid crystal panel 11 together with the flat plate shape section 36 of the frame section 16 therebetween. Therefore, the facing section 22 needs to surely face the outer edge section of the liquid crystal panel 11, and additionally, in the facing section 22, the thinner setting thereof is made as much as possible, the easier realization of thin bezel configuration is able to be made.

The diffuser plate holding section 13b of the displacement prevention member 21 includes a flat section 52 that continues into the facing section 22 and covers an end on the front side Z1 of the sidewall section 44 of the chassis 12, and an inner section 54 that covers the sidewall section 44 from an inner periphery side. An end on the front side Z1 of the inner section 54 is formed by continuing into to an end located inside in a planar direction of the flat section 52. Then, at the end on the front side Z1 of the inner section 54, a surface on an opposite side to a surface in contact with the sidewall section 44 of the chassis 12 is formed in a curved surface to become the reflection surface 54a that supports an outer edge section of the diffuser plate 41.

Further, in the inner section 54 of the displacement prevention member 21, on the side of the surface in contact with the sidewall section 44 of the chassis 12, one or a plurality of holes 53 are formed, and an internal thread is formed in the hole 53. Into the hole 53, the connecting member 17 that is achieved by a thread member is inserted. The connecting member 17 is threadably mounted on the hole 53 of the inner section 54 so that the displacement prevention member 21 is connected to the chassis 12. Note that, the hole 53 is formed without penetrating the inner section 54. Whereby, light is prevented from being transmitted through the inner section 54. Moreover, the displacement prevention member 21 includes an engaging section that engages with the sidewall section 44 of the chassis 12, and the sidewall section 44 includes an engaged section that is engaged with the engaging section. In a state where the engaging section engages to the engaged section, and connection of the sidewall section 44 to the displacement prevention member 21 by the connecting member 17 is released, the contact section 24 is pivotably displaced with respect to the chassis 12 on a fulcrum at the engaged section. Additionally, the contact section 24 is pivotably displaced so as to come close to and be apart from the liquid crystal panel 11.

In the displacement prevention member 21, the reflection surface 54a formed in a curved surface at an end on the front side Z1 of the inner section 54 has a convex parabolic or arc shape on the front side Z1, and has an arc shape in the embodiment. Moreover, at least a part of the reflection surface 54a is disposed so as to be located inside in the planar direction on a display screen in the liquid crystal panel 11, that is, located in an effective display area.

In the embodiment, the arc-shaped reflection surface 54a has a cross-sectional shape vertical to the short side direction Y that is a ¼ circle whose center angle is 90°, and is uniformly formed in the short side direction Y. Further, the arc-shaped reflection surface 54a has the length H₁ in the thickness direction Z that is the same as the curvature radius r₁. The ratio (H₁/H₂) of the length H₁ in the thickness direction Z of the reflection surface 54a to the length H₂ in the thickness direction Z of the diffuser plate holding section 13b, that is, the length H₂ from a surface on the back side Z2 of the diffuser plate 41 to the bottom section 39 of the chassis 12 can be appropriately set according to the size of thin bezel configuration of the image display apparatus 10, a heat deformation ratio and a diffusion rate of the diffuser plate 41, and the like, and is set to 0.05 or more. In a case where the (H₁/H₂) is less than 0.05, the length in the long side direction X of the reflection surface 54a is too short to support an outer edge section of the diffuser plate 41, and the diffuser plate 41, in the case of being exposed to a low temperature to be contracted, may be deviated to be fallen out or have light that does not reach the end.

As described above, the diffuser plate 41 in the image display apparatus 10 of the embodiment has a corner section on the back side Z2 of an outer edge section thereof that is supported by the reflection surface 54a formed in a curved surface at the diffuser plate holding section 13b that reflects light emitted from the light source 32, and the light emitted from the light source 32 is thus enabled to be entered between the diffuser plate 41 and the reflection surface 54a at an outer edge section of the diffuser plate 41, and it is thus possible to directly irradiate a surface on the back side Z2 of the outer edge section with light. This makes it possible to suppress lowering of an outgoing efficiency with respect to the light emitted from the light source 32, and it is thus possible to suppress deterioration of luminance uniformity on a display screen. Additionally, it is possible for the light emitted from the light source 32 to be entered between the diffuser plate 41 and the reflection surface 54a at the outer edge section of the diffuser plate 41, thus having smooth decay of a light quantity at the outer edge section of the diffuser plate 41, and it is thus possible to obscure ununiformity of a display screen.

Further, in the image display apparatus 10 of the embodiment, even in a case where the diffuser plate 41 is exposed to a low temperature to be contracted before starting up of the apparatus and the like, when the diffuser plate 41 is expanded by heat that is generated from the light source 32 in completion of stating up of the apparatus, an outer edge section of the diffuser plate 41 is guided to the reflection surface 54a formed in a curved surface to be able to return smoothly to an original position before contraction. This makes it possible to suppress lowering of an outgoing efficiency with respect to the light emitted from the light source 32, and it is thus possible to suppress deterioration of luminance uniformity on a display screen.

Further, in the image display apparatus 10 of the embodiment, the holding structure 13 is disposed so that at least a part of the reflection surface 54a of the diffuser plate holding section 13b is located inside in a planar direction on a display screen in the liquid crystal panel 11. Since the image display apparatus 10 is configured so that the reflection surface 54a of the diffuser plate holding section 13b is formed in a curved surface so as to enable light emitted from the light source 32 to be entered between the diffuser plate 41 and the reflection surface 54a in an outer edge section of the diffuser plate 41, even when at least a part of the reflection surface 54a is located inside in the planar direction on the display screen in the liquid crystal panel 11, that is, at least a part of the reflection surface 54a is located in an effective display area according to thin bezel configuration in which widths of the chassis 12 and the frame section 16 are made smaller, it is possible to suppress deterioration of the luminance uniformity on a display screen.

Moreover, the image display apparatus 10 of the embodiment further comprises the optical sheet 40 and a plurality of projecting sections 42.

The optical sheet 40 is disposed between the diffuser plate 41 and the liquid crystal panel 11 on the front side Z1 of the diffuser plate 41, and changes an optical property of light that is transmitted through the diffuser plate 41. The optical sheet 40 turns a propagation direction of light that reaches from the back side Z2 via the diffuser plate 41 to the front side Z1. In the diffuser plate 41, in order to prevent luminance from being ununiformly distributed in the planar direction thereof, many components in the planar direction are included as vector components in the propagation direction of light. On the other hand, the optical sheet 40 converts a propagation direction of light including many vector components in the planar direction thereof into a propagation direction of light including many components in the thickness direction Z. Specifically, the optical sheet 40 has many parts formed in a lens shape or a prism shape that are formed alongside in the planar direction, thereby reducing diffusion of light propagating in the thickness direction Z. Accordingly, it is possible to increase luminance in display by the image display apparatus 10. Additionally, the functions of the optical sheet 40 are not limited to the above, and the optical sheet 40 may be an optical sheet that enhances a diffusion rate of the diffuser plate 41, or enhances luminance by utilizing polarizing reflection.

Note that, in the image display apparatus 10, all of the liquid crystal panel 11, the bottom section 39 of the chassis 12, the optical sheet 40 and the diffuser plate 41 are formed in a rectangular shape when viewed in the thickness direction Z of the liquid crystal panel 11, and each of which has a long side direction X that is parallel to each other, as well as each of which has a short side direction Y that is parallel to each other.

Each of a plurality of projecting sections 42 is vertically disposed toward the diffuser plate 41 from the bottom section 39 of the chassis 12, and regulates flexural deformation of the diffuser plate 41. Height of each projecting section 42 from the bottom section 39 is set to height such that a tip end on the liquid crystal panel 11 side of the projecting section 42 comes in contact with the diffuser plate 41 at normal temperature, or height such that a tip end on the liquid crystal panel 11 side of the projecting sections is slightly apart from the diffuser plate 41 at normal temperature. Whereby, the projecting section 42 regulates flexural deformation of the optical sheet 40 and the diffuser plate 41 to the back side Z2.

In the image display apparatus 10 configured in this manner, in the diffuser plate 41, the outer edge section is supported by the diffuser plate holding section 13b, displacement thereof to a liquid crystal panel 11 side is regulated by the optical sheet 40, and the displacement thereof to the bottom section 39 side of the chassis 12 is regulated by the projecting section 42. Therefore, since the diffuser plate 41 comes to be subjected to three-dimensional position regulation by the diffuser plate holding section 13b, the optical sheet 40 and the projecting section 42, even in a case where a size of the diffuser plate 41 is made smaller according to thin bezel configuration in which widths of the chassis 12 and the frame section 16 are made smaller, it is possible to prevent the diffuser plate 41 from being deviated to be fallen out.

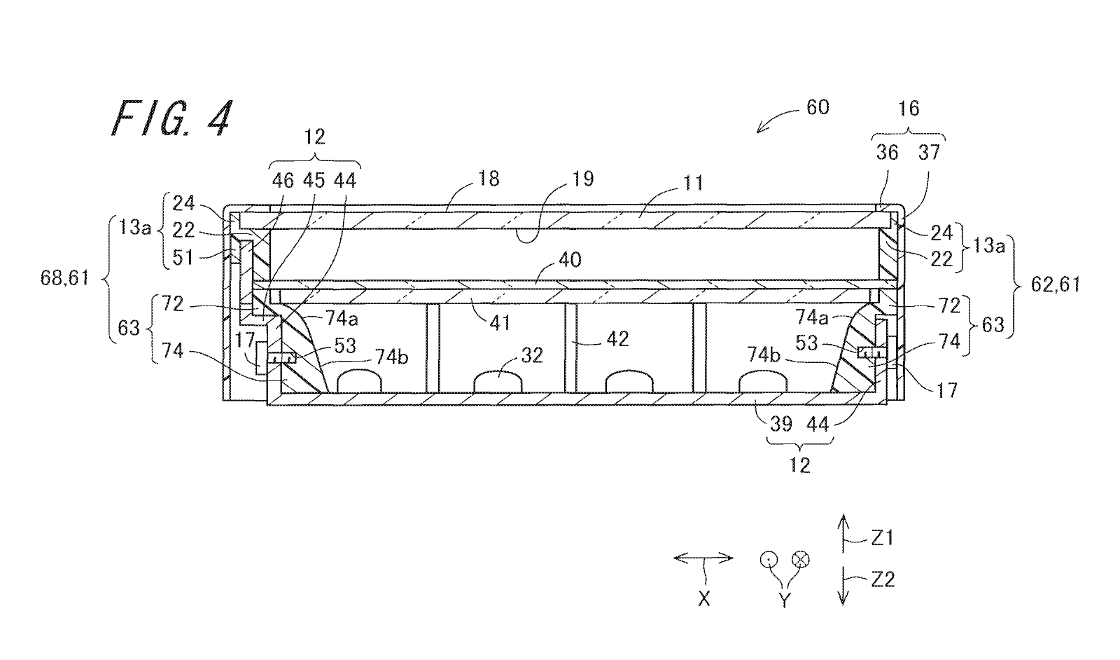

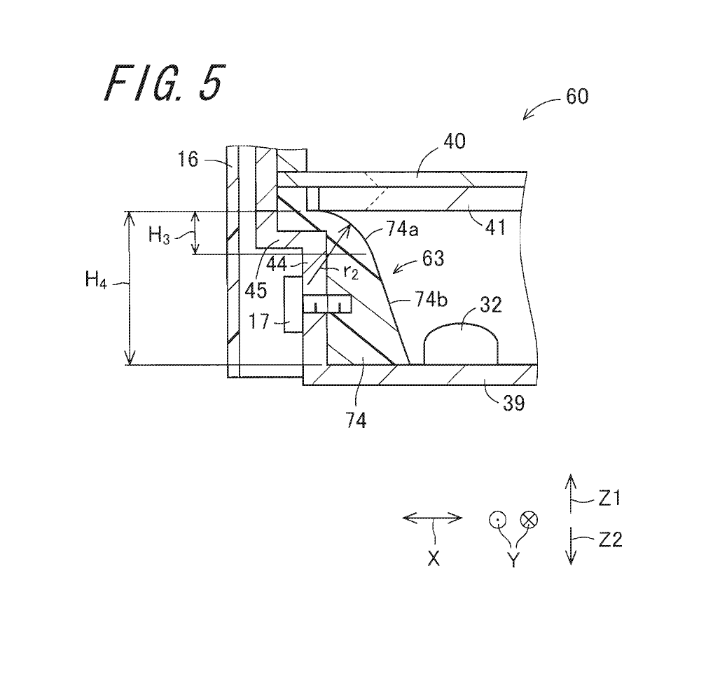

FIG. 4 is a view showing a configuration of an image display apparatus 60 according to another embodiment. FIG. 5 is an enlarged view showing a main part of the image display apparatus 60. The image display apparatus 60 of the embodiment is similar to the above-described image display apparatus 10, and the corresponding parts are denoted by the same reference numerals, and description thereof is omitted. The image display apparatus 60 is configured similar to the image display apparatus 10 except that a holding structure 61 is provided in place of the above-described holding structure 13.

The holding structure 61 provided in the image display apparatus 60 includes a displacement prevention member 62, and a fit fixation member 68 that is fitted and fixed to the chassis 12, and the displacement prevention member 62 and the fit fixation member 68 are connected to each other to form a frame shape. Additionally, the displacement prevention member 62 and the fit fixation member 68 comprise a panel holding section 13a and a diffuser plate holding section 63, respectively. The panel holding section 13a holds the outer edge section of the liquid crystal panel 11 together with the frame section 16 therebetween to hold the liquid crystal panel 11. The diffuser plate holding section 63 has a reflection surface 74a serving as a supporting surface that is formed in a curved surface, and supports an outer edge section of the diffuser plate 41 with the reflection surface 74a to hold the diffuser plate 41.

The fit fixation member 68 is fitted and fixed to at least the collar section 46 of the chassis 12. In the embodiment, the panel holding section 13a of the fit fixation member 68 is configured similar to the above-described panel holding section 13a of the fit fixation member 48, and thus description thereof is omitted.

The diffuser plate holding section 63 of the fit fixation member 68 includes a flat section 72 that continues into the fitting section 51 and covers the front side Z1 of the flange section 45, and an inner section 74 that covers the sidewall section 44 of the chassis 12 from an inner periphery side. An end on the front side Z1 of the inner section 74 is formed by continuing into an end located inside in a planar direction of the flat section 72. Additionally, at the end on the front side Z1 of the inner section 74, a surface on an opposite side to a surface in contact with the sidewall section 44 of the chassis 12 is formed in a curved surface to become the reflection surface 74a that supports an outer edge section of the diffuser plate 41.

Further, in the inner section 74 of the fit fixation member 68, on the side of the surface in contact with the sidewall section 44 of the chassis 12, one or a plurality of holes 53 are formed, and an internal thread is formed in the hole 53. Into the hole 53, the connecting member 17 that is achieved by a thread member is inserted. The connecting member 17 is threadably mounted on the hole 53 of the inner section 74 so that the fit fixation member 68 is connected to the chassis 12. Note that, the hole 53 is formed without penetrating the inner section 74. Whereby, light is prevented from being transmitted through the inner section 74.

In the fit fixation member 68, the reflection surface 74a formed in a curved surface at the end on the front side Z1 of the inner section 74 has a convex parabolic or arc shape on the front side Z1, and has an arc shape in the embodiment. Moreover, at least a part of the reflection surface 74a is disposed so as to be located inside in a planar direction on a display screen in the liquid crystal panel 11, that is, located in an effective display area.

In the embodiment, the arc-shaped reflection surface 74a has a cross-sectional shape vertical to the short side direction Y that is a ⅛ circle whose center angle is 45°, and is uniformly formed in the short side direction Y. Further, in the arc-shaped reflection surface 74a, a length H₃ in the thickness direction Z is represented as the following equation (1) with use of a curvature radius r₂.

$${H}_{3} = {\cdot }_{2} - \frac{{r}_{2}}{\sqrt{2}} \qquad ( 1 )$$

A ratio (H₃/H₄) of the length H₃ in the thickness direction Z of the reflection surface 74a to a length H₄ in the thickness direction Z of the diffuser plate holding section 63, that is, a length H₄ from a surface on the back side Z2 of the diffuser plate 41 to the bottom section 39 of the chassis 12 can be appropriately set according to the size of thin bezel configuration of the image display apparatus 10, a heat deformation ratio and a diffusion rate of the diffuser plate 41, and the like, and is set to be smaller than the above-described (H₁/H₂), and to 0.025 or more. In a case where the (H₃/H₄) is less than 0.025, the length in the long side direction X of the reflection surface 74a is too short to support an outer edge section of the diffuser plate 41, and the diffuser plate 41, in the case of being exposed to a low temperature to be contracted, may be deviated to be fallen out or have light that does not reach the end.

Further, the diffuser plate holding section 63 of the fit fixation member 68 has an inclined surface 74b that is inclined toward the bottom section 39 of the chassis 12 that is laid in a direction coming close to the light source 32 from the reflection surface 74a. This makes it possible to allow light emitted from the light source 32 to be reflected toward the diffuser plate 41 with the inclined surface 74b, and it is thus possible to further suppress deterioration of luminance uniformity on a display screen.

The displacement prevention member 62 is disposed corresponding to parts where the collar section 46 of the chassis 12 is not disposed. In the embodiment, the panel holding section 13a of the displacement prevention member 62 is configured similar to the above-described panel holding section 13a of the displacement prevention member 21, and thus description thereof is omitted.

The diffuser plate holding section 63 of the displacement prevention member 62 includes a flat section 72 that continues into the facing section 22 and covers an end on the front side Z1 of the sidewall section 44 of the chassis 12, and the inner section 74 that covers the sidewall section 44 from an inner periphery side. An end on the front side Z1 of the inner section 74 is formed by continuing into an end located inside in a planar direction of the flat section 72. Additionally, at the end on the front side Z1 of the inner section 74, a surface on an opposite side to a surface in contact with the sidewall section 44 of the chassis 12 is formed in a curved surface to become the reflection surface 74a that supports an outer edge section of the diffuser plate 41.

Further, in the inner section 74 of the displacement prevention member 62, on the side of the surface in contact with the sidewall section 44 of the chassis 12, one or a plurality of holes 53 are formed, and an internal thread is formed in the hole 53. Into the hole 53, the connecting member 17 that is achieved by a thread member is inserted. The connecting member 17 is threadably mounted on the hole 53 of the inner section 74 so that the displacement prevention member 62 is connected to the chassis 12. Note that, the hole 53 is formed without penetrating the inner section 74. Whereby, light is prevented from being transmitted through the inner section 74. Moreover, the displacement prevention member 62 includes an engaging section that engages to the sidewall section 44 of the chassis 12, and the sidewall section 44 includes an engaged section that is engaged to the engaging section. In a state where the engaging section engages to the engaged section, and connection of the sidewall section 44 to the displacement prevention member 62 by the connecting member 17 is released, the contact section 24 is pivotably displaced with respect to the chassis 12 on a fulcrum at the engaged section. Additionally, the contact section 24 is pivotably displaced so as to come close to and be apart from the liquid crystal panel 11.

In the displacement prevention member 62, the reflection surface 74a formed in a curved surface at an end on the front side Z1 of the inner section 74 has a convex parabolic or arc shape on the front side Z1, and has an arc shape in the embodiment. Moreover, at least a part of the reflection surface 74a is disposed so as to be located in the inside in the planar direction on a display screen in the liquid crystal panel 11, that is, located in an effective display area.

In the embodiment, the arc-shaped reflection surface 74a has a cross-sectional shape vertical to the short side direction Y that is a ⅛ circle whose center angle is 45°, and is uniformly formed in the short side direction Y. Further, in the arc-shaped reflection surface 74a, the length H₃ in the thickness direction Z is represented as the above-described equation (1) with use of the curvature radius r₂. A ratio (H₃/H₄) of the length H₃ in the thickness direction Z of the reflection surface 74a to the length H₄ in the thickness direction Z of the diffuser plate holding section 63, that is, the length H₄ from a surface on the back side Z2 of the diffuser plate 41 to the bottom section 39 of the chassis 12 can be appropriately set according to the size of thin bezel configuration of the image display apparatus 10, a heat deformation ratio and a diffusion rate of the diffuser plate 41, and the like, and is set to be smaller than the above-described (H₁/H₂), and to 0.025 or more. In a case where the (H₃/H₄) is less than 0.025, the length in the long side direction X of the reflection surface 74a is too short to support an outer edge section of the diffuser plate 41, and the diffuser plate 41, in the case of being exposed to a low temperature to be contracted, may be deviated to be fallen out or have light that does not reach the end.

Further, the diffuser plate holding section 63 of the displacement prevention member 62 also has an inclined surface 74b that is inclined toward the bottom section 39 of the chassis 12 that is laid in a direction coming close to the light source 32 from the reflection surface 74a. This makes it possible to allow light emitted from the light source 32 to be reflected toward the diffuser plate 41 with the inclined surface 74b, and it is thus possible to further suppress deterioration of luminance uniformity on a display screen.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. An image display apparatus comprising:
a liquid crystal panel having a liquid crystal element that displays an image on a display screen arranged on one side thereof, with the liquid crystal element;
a base that is arranged on another side opposite to the one side of the liquid crystal panel, and has a bottom plate and a sidewall disposed on a lateral part of the bottom plate;
a member that faces an outer edge section of the liquid crystal panel from the one side thereof, and prevents relative displacement to the one side of the liquid crystal panel;
a light source that is disposed on the bottom plate of the base, and irradiates the liquid crystal panel with light from the other side of the liquid crystal panel;
a diffuser plate that is disposed between the light source and the liquid crystal panel, and diffuses light emitted from the light source; and
a holding structure having a frame shape that is disposed on the sidewall of the base, reflects light emitted from the light source and holds the diffuser plate, the holding structure being provided with a diffuser plate holding section that supports an outer edge section of the diffuser plate on a supporting surface formed in a curved surface.

2. The image display apparatus of claim 1, wherein the diffuser plate holding section has an inclined surface that is inclined toward the bottom plate that is laid in a direction coming close to the light source from the supporting surface.

3. The image display apparatus of claim 1, wherein the supporting surface of the diffuser plate holding section has an arc shape.

4. The image display apparatus of claim 1, wherein the holding structure is disposed so that at least a part of the supporting surface of the diffuser plate holding section is located inside in a planar direction on the display screen in the liquid crystal panel.

5. The image display apparatus of claim 1, further comprising:
an optical sheet that is disposed between the diffuser plate and the liquid crystal panel, and changes an optical property of light that is transmitted through the diffuser plate; and
a projecting section that is vertically disposed toward the diffuser plate from the bottom plate of the base, and regulates flexural deformation of the diffuser plate.
